(19) United States
(12) Patent Application Publication
(10) Pub. No.: US 2025/0326429 A1
(43) Pub. Date: Oct. 23, 2025

(54) ELECTRONIC STEERING SYSTEMS FOR VEHICLES AND METHODS FOR OPERATING ELECTRONIC STEERING SYSTEMS

(71) Applicant: Ford Global Technologies, LLC, Dearborn, MI (US)

(72) Inventors: Alexander Ein Waldt, Köln (DE); Oliver Nehls, Düsseldorf (DE); Sergio Codonesu, Aachen (DE); Goetz-Philipp Wegner, Dortmund (DE); Gerhard Friederich, Bornheim (DE)

(21) Appl. No.: 19/180,664

(22) Filed: Apr. 16, 2025

(30) Foreign Application Priority Data
Apr. 17, 2024 (DE) 102024110822.3

(51) Int. Cl. B62D 5/04

(52) U.S. Cl. CPC B62D 5/0487; B62D 5/0484

(57) ABSTRACT

An example electronic steering system for a vehicle includes a first inverter coupled to a first winding set of an electric motor, the first inverter to provide first power to the first winding set, a second inverter coupled to a second winding set of the electric motor, the second inverter to provide second power to the second winding set, and a third inverter including first power electronics coupled to the first winding set, the first power electronics to provide third power to the first winding set, second power electronics coupled to the second winding set, the second power electronics to provide fourth power to the second winding set, and a control device to cause the first power electronics to provide the third power and a portion of the first power to the first winding set after limited operating condition of the first inverter.

### RELATED APPLICATION

This patent claims priority from DE Patent Application Number 102024110822.3, which was filed on Apr. 17, 2024, and is hereby incorporated by reference in its entirety.

### FIELD OF THE DISCLOSURE

The disclosure relates in general to electronic steering systems for vehicles and to methods for operating electronic steering systems.

### BACKGROUND

Electronic steering systems are an emerging steering technology that dispenses with the mechanical connection between steering wheel and road wheel and replaces it with two actuators: an actuator that produces a torque for feedback to the driver (at the steering wheel), and a wheel actuator that adjusts the road wheels into the desired position.

### SUMMARY

An example electronic steering system for a vehicle includes a first inverter coupled to a first winding set of an electric motor, the first inverter to provide first power to the first winding set, a second inverter coupled to a second winding set of the electric motor, the second inverter to provide second power to the second winding set, and a third inverter including first power electronics coupled to the first winding set, the first power electronics to provide third power to the first winding set, second power electronics coupled to the second winding set, the second power electronics to provide fourth power to the second winding set, and a control device to cause the third inverter to provide the third power, the fourth power, and a portion of the first power, or a portion of the second power based on an unavailability of the first inverter or the second inverter.

An example method for operating an electronic steering system for a vehicle includes detecting an unavailability of a first inverter coupled to a first winding set or an unavailability of a second inverter coupled to a second winding set, and selectively coupling a third inverter to either the first winding set or the second winding set corresponding to the unavailable inverter or to at least one additional third winding set.

An example electronic steering system for a vehicle includes a first power supply, a second power supply, a first inverter coupled to the first power supply and a first winding set of an electric motor, the first inverter to provide first power to the first winding set, a second inverter coupled to the second power supply and to a second winding set of the electric motor, the second inverter to provide second power to the second winding set, and a third inverter including first power electronics coupled to the first power supply and to the first winding set, the first power electronics to provide third power to the first winding set, second power electronics coupled to the second power supply and to the second winding set, the second power electronics to provide fourth power to the second winding set, and a control device to cause the second power electronics to provide the fourth power and a portion of the first power to the second winding set after an unavailability of the first power supply.

### BRIEF DESCRIPTION OF THE DRAWINGS

FIG. 1 shows a vehicle including an example electronic steering system.

FIG. 2 is a flowchart representative of example machine-readable instructions and/or example operations that may be executed, instantiated, and/or performed by example programmable circuitry to implement example methods disclosed herein for operating a vehicle including an electronic steering system.

FIGS. 3 to 8 show an example actuator of the electronic steering system according to some examples disclosed herein.

FIG. 9 is a block diagram of an example processing platform including programmable circuitry structured to execute, instantiate, and/or perform the example machine readable instructions and/or perform the example operations of FIG. 2.

In general, the same reference numbers will be used throughout the drawing(s) and accompanying written description to refer to the same or like parts. The figures are not necessarily to scale.

### DETAILED DESCRIPTION

In examples disclosed herein, unexpected operating condition, limited operating condition, unexpected operating state, and limited operating state may be used interchangeably to refer to a condition or a state of a component that is unavailable, inoperable, and/or operating outside of an operating specification performance range of the component.

Since an unexpected operating condition in an electronic steering system can potentially lead to a loss of steering capability, redundant systems are employed. Some approaches involve a forced reduction in speed of the vehicle in the event of an unexpected operating condition of a inverter (e.g., a converter), although this reduces the functionality of the vehicle. In addition, a forced reduction in speed of a vehicle when there is an unexpected operating condition in a inverter is generally uncomfortable for the driver.

Other approaches, therefore, involve, for example, a control mechanism for controlling a redundant actuator having two sub-actuators, in particular an electric motor having two separate winding sets (see DE 102021112819 A1). The electric motor has a first actuator connection and a second actuator connection. A inverter is coupled to each actuator connector. In the event of an unexpected operating condition in an actuator, an additional third inverter can be coupled to the actuator connection, whereby the electric motor can continue to operate to output its maximum nominal torque, or at least a torque that is equivalent to the power from one inverter if an unexpected operating condition occurs for two inverters. This follows an approach in which the third inverter has the same power capability as the first two inverters, however. As a result, the electronic steering system is complex. In addition, the thermal load on the overall supply circuit for the electric motor is high.

EP 3643583 A1 and DE 102018108597 A1 disclose in this context that an electric motor can be operated with two mutually redundant inverters. US 2023/0013239 A1, US 2021/0276613 A1 and U.S. Pat. No. 11,780,493 B2 disclose steering systems having redundant component groups, on the basis of which it is still possible, after an unexpected operating condition of the steering system, to have a reduced functionality e.g., a reduction in the maximum speed). According to these approaches, however, in the event of an unexpected operating condition in a inverter, just a single redundancy level is provided, and fully redundant component groups mean that the complexity is high.

Examples disclosed herein overcome the disadvantages of known methods and electronic steering systems. In particular, examples disclosed herein provide methods and electronic steering systems in which multiple redundancies can be provided but in which the complexity and thermal load of the overall supply circuit for an electric motor can be reduced compared with previous approaches.

Some examples disclosed herein are reflected in the independent claims. The dependent claims and the description below define other examples, each of which can represent individually or in (sub-) combinations aspects of the disclosure. Some features are explained regarding methods, others regarding devices. The relevant aspects can be applied reciprocally in an appropriate manner, however.

According to one aspect, some examples of the disclosure relate to electronic steering systems for vehicles. An electronic steering system includes at least one actuator having an electric motor, and at least three inverters, which are coupled to the electric motor. The electric motor has at least two mutually independent winding sets. A first inverter is coupled to a first winding set of the electric motor. A second inverter is coupled to a second winding set of the electric motor. A third inverter can be coupled selectively both to the first and/or the second winding set or to at least one additional third winding set of the electric motor. The inverters are configured in such a way that a total maximum power output from the inverters to the electric motor may equal 133% of a nominal actuator power demand.

The present disclosure is based on the third inverter not having to have the same electrical power features as the first inverter and the second inverter to provide dual redundancy for continued operation of the vehicle. An electronic steering system is, thereby, provided which has dual redundancy in terms of the actuator yet compared with known approaches, and enables reduced complexity. Unlike known approaches, there is no need for the third inverter, which facilitates the second redundancy level, to have the same power parameters as the first and second inverters, as long as the first and second inverters are configured such that they jointly guarantee 100% of the power capability of the electric motor. In other words, the third inverter can advantageously be configured to have a power capability that is less than that of the first inverter and of the second inverter (e.g., can output at most an electrical power that is lower than that of the first inverter and of the second inverter). As a result, a less complex component can advantageously be used for the third inverter, thereby, reducing the complexity of the electronic steering system. Alternatively, each of the inverters can be less complex if the power gain is distributed between each of the inverters. In addition, the power reduction results in a reduction in the thermal load regarding the circuits for controlling the electric motor of the actuator compared with existing approaches. This advantageously extends the operating life of the circuits for controlling the electric motor of the actuator. In addition, installation space can be saved as a result of the reduced electrical output power from the third inverter. Thus, the electronic steering system offers numerous advantages over existing approaches, for instance, the advantage of the steering system operating with high availability.

According to one aspect, some examples of the disclosure also relate to methods of operating electronic steering systems for vehicles. An electronic steering system includes at least one actuator having an electric motor, and at least three inverters, which are coupled to the electric motor. The electric motor has at least two mutually independent winding sets. A first inverter is coupled to a first winding set of the electric motor. A second inverter is coupled to a second winding set of the electric motor. The electronic steering system also has a third inverter. The inverters are configured in such a way that a combined total maximum power output from each of the inverters to the electric motor may equal 133% of a nominal actuator power demand. A method includes at least detecting an unexpected operating condition in the electronic steering system such that a inverter can no longer be used, and selectively coupling the third inverter both to the first and/or the second winding set or to at least one additional third winding set of the electric motor.

The advantages achieved by the herein-described electronic steering system are also achieved in a corresponding manner by the method for operating an electronic steering system.

An actuator shall be understood to mean a component that causes a mechanical force to be transmitted to a driven component, for example, to a steering rack or a steering column. For this purpose, the actuator includes an electric motor, the operation of which is controlled by an electronic control unit assigned to the actuator.

In some examples, the electronic control unit includes at least one control logic unit and a power electronics unit assigned to the control logic unit. The power electronics unit is part of a inverter, to which the corresponding control logic unit is assigned. The power electronics unit includes a plurality of power switches, for instance, transistors.

In some examples, a single control logic unit generally of different electronic control units can also be assigned to a plurality of separate power electronic units. For example, a control logic unit can be configured to control the switching states of at least two power electronics units, which have different sets of power switches.

In some examples, a control logic unit in general includes at least one data processing device and sensor devices, diagnostic circuits, communication devices and/or driver circuits relating to the associated power electronics unit of the particular inverter.

In some examples, the actuator can be a wheel actuator or a steering-wheel actuator.

In some examples, the electronic steering system can also include two actuators, a wheel actuator and a steering-wheel actuator, which are each of suitable design and can be coupled to three inverters assigned to the actuator. The functionality of the above-described electronic steering system can then be transferred correspondingly to both actuators.

In some examples, the actuator is a wheel actuator and is coupled at least indirectly to a steerable road wheel of the vehicle. The wheel actuator does not have to be coupled directly to a steerable road wheel of the vehicle. This means that the wheel actuator can also be coupled to the steerable road wheel via a further mechanical component, for instance, a steering rack of the electronic steering system. A movement of the steering rack out of a reference position (e.g., a zero position) can result in, for example, a direct deflection of the steerable road wheels of the vehicle out of a reference direction (e.g., a straight ahead direction).

In some examples, the actuator is a steering-wheel actuator, and is coupled at least indirectly to a steering wheel of the vehicle, for instance, via a steering column to which the steering wheel is attached. A movement of the steering-wheel actuator can then exert a torque on the steering column, which induces a torque on the steering wheel to provide the driver of the vehicle with torque feedback regarding the lateral guidance of the vehicle.

Each winding set can include a group of a plurality of individual windings that are assigned to each other and to which different phase voltages can be applied to drive phase currents in the respective windings. The winding sets are in general configured with respect to the stator. The rotor of the electric motor can, thus, be driven by the generated phase currents. Finally, the electric motor can, thus, output a torque provided via the rotor to an external mechanical component, for instance, to a pinion that interacts with the steering rack.

Other designs of the winding sets and/or electric motors are also conceivable.

In general, each inverter includes a plurality of power switches, which can be controlled by a control logic unit to provide phase voltages for the windings of a winding set.

In some examples, the winding sets of the electric motor can include the same design. This means that the winding sets can include the same number of windings.

The maximum power output from a inverter shall be understood to mean the maximum electrical power that can be output by a defined inverter, specifically in relation to the collective group of all the windings of a winding set that are supplied by the given inverter.

The nominal actuator power demand (nAPD) shall be understood to mean the electrical power demand that the electric motor must receive in total across the group of all its winding sets to output its nominal maximum torque at its output.

The stated limit values, for example, an nAPD of 133%, an nAPD of 66% or an nAPD of 33% (or other values stated herein) should not be interpreted as limited to the exact numerical value in each example. Each can include a tolerance band of ±5% points. On the basis thereof, it can be assumed that an nAPD of 33% also includes an nAPD of 34%.

Power demands discussed herein can be understood to mean the power demands that are output over an electrical period of the control of the electric motor (e.g., are averaged in time over the electrical period). The different time points during the electrical period depend here on the relative overlap between a rotor and a stator, for instance, rotor teeth with respect to stator teeth. By averaging over the electrical pole cycle, the average can be found across the relative overlap between rotor and stator for the entire electronic period.

In some examples, a power demand can also be understood to mean the instantaneous power demand at a defined point in time (e.g., the power demand as a function of the overlap between rotor and stator).

An unexpected operating condition in the electronic steering system can include a inverter that can no longer be controlled such that it can operate, or the existence of an unexpected operating condition in a power supply relating to a inverter. As a result of the various unexpected operating conditions of the electronic steering system, after a first unexpected operating condition (e.g., an unexpected operating condition in a inverter or a power supply), at least one inverter is no longer usable. In such examples, the functionality of the electronic steering system can be provided by the operational or available inverters (e.g., inverters not associated with a limited operating condition).

In some examples, after the first unexpected operating condition, a further unexpected operating condition (e.g., an unexpected operating condition) relating to a further inverter occurs, for instance, relating to the inverter of the first and second inverters that was still usable following the first unexpected operating condition.

In some examples, the inverters are configured to be connected to the winding sets in such a way that the electric motor, in the event of an unexpected operating condition in a inverter or an unexpected operating condition in a power supply, can still operate at least in a first mode, in which a total power output from the inverters operating in normal conditions to the electric motor still equals at least 66% of the nominal actuator power demand (nAPD). As a result, the electric motor of the actuator can still produce sufficient torque to continue operating the vehicle with the electronic steering system indefinitely, even though the electronic steering system has an unexpected operating condition corresponding to a inverter of the relevant actuator. Indefinitely here refers to a potential limit in terms of time. In other words, if the remaining inverters coupled to the electric motor of the relevant actuator can still provide 66% of the nAPD, the electric motor can still output a sufficient torque to the associated component, for example, the steerable vehicle wheels or the steering wheel, for no (lasting) limit on the functionality of the electronic steering system.

In some examples, the inverters are configured to be connected to the winding sets in such a way that in the event of a second unexpected operating condition in a further inverter or, if initially solely a first unexpected operating condition in a inverter exists, in the event of a subsequent power supply unexpected operating condition, the electric motor can still operate at least in a second mode, in which the power output from the operational or available inverter (e.g., a inverter not associated with a limited operating condition) to the electric motor still equals at least 33% of the nAPD. This can allow the electronic steering system to continue to operate. For example, despite the occurrence of two unexpected operating conditions relating to inverters or a combination of unexpected operating conditions relating to a inverter and a power supply, which can be coupled to the same actuator, the vehicle can still operate with the electronic steering system in a specific mode. For example, the torque output by the electric motor to the relevant mechanical component, for example, to the steerable road wheels or the steering wheel, can still be sufficient to be able to steer the vehicle in a limited state.

The configuration in which the electric motor can still operate with 33% of the nAPD, for instance, after two successive unexpected operating conditions in different inverters, also ensures that an unexpected operating condition in a inverter followed by a second unexpected operating condition in a inverter or a power supply, for instance, of a supply circuit, still provides enough power for the electronic steering system to still be able to operate. In response to a first unexpected operating condition in the power supply (e.g., a supply circuit), the vehicle is taken immediately into a specific state, for instance, a low-speed state (e.g., a creep state, a creep-home state, etc.). This likewise merely requires that the electric motor can at least still operate with 33% of the nAPD. This is because it cannot be ensured that after a first unexpected operating condition in the power supply (of a supply circuit), a subsequent unexpected operating condition is not also related to a (further) power supply, for example, of an alternative supply circuit.

In some examples, the third inverter is configured such that per winding set of the electric motor a maximum of 33% of the nAPD can be output by the third inverter to the associated winding set. This makes clear that the third inverter advantageously does not even have to guarantee 50% of the nAPD for a winding set. This means that the third inverter can be more compact than the first and second inverters, thereby, reducing the complexity of the electronic steering system, in particular compared with existing approaches.

In some examples, the inverters are configured to be connected to the winding sets in such a way that each winding set of the electric motor can be supplied with a power output of 50% maximum of the nAPD. This can deter from having to design the winding sets of the electric motor for an unnecessarily high power. Advantageously, this also results in the electronic steering system being more compact in terms of the actuator.

In some examples, the third inverter can be selectively coupled in addition to a fourth winding set of the electric motor. This provides additional switching configurations by the group of inverters that are assigned to the actuator. The versatility of the electric motor of the electronic steering system is, thereby, increased.

In some examples, a separate control logic unit is assigned to each inverter, wherein the plurality of control logic units are coupled to one another. The control logic units of the inverters assigned to a single actuator are, thus, also assigned as a group to the actuator. The coupling to one another simplifies the overall control by the group of control logic units.

In other examples, inverters are assigned to a common actuator are assigned a single shared control logic unit. In other words, the single shared control logic unit of the group of inverters assigned to a specific actuator can then provide the control of all the inverters for this actuator. In such examples, the electronic steering system is particularly compact.

In some examples, an unexpected operating condition notification is output for a driver of the vehicle in the event of an unexpected operating condition in at least one inverter or a power supply. This can advantageously inform the driver of the vehicle about the unexpected operating condition. The driver is consequently notified that the electronic steering system should/must be inspected.

In some examples, a reduction in the maximum speed of the vehicle can be induced in the event of an unexpected operating condition in at least one inverter or a power supply. In some examples, the electronic steering system can have at least one control logic unit which, as a result of an unexpected operating condition in a inverter or a power supply, limits a higher-level driving functionality of the vehicle, namely the maximum speed that can be achieved. For this purpose, the control logic unit of the electronic steering system can be coupled, for example, to a higher-level driving control device of the vehicle, and can output a suitable control signal to the driving control device. The driving control device can itself have a suitably configured control logic unit.

In some examples, following the detection of an unexpected operating condition in a inverter or a power supply, a maximum speed of the vehicle can be limited to a speed equal to a limited speed (e.g., a slow speed, a creep-home speed). This can guarantee that unintentional driving states of the vehicle are avoided despite the presence of an unexpected operating condition in a inverter.

The electric motor is 3n-phase, where n is greater than or equal to 1, in some examples, greater than 1. Each phase of the electric motor is formed by a winding of a winding set. Each winding set can include three windings. Consequently, the electric motor has at least one or more winding sets (e.g., 2, 3, 4, etc.). This increases the versatility of the electronic steering system.

Typically, each inverter and each individual power electronics unit of a inverter is coupled to a separate winding set of the electric motor. In some examples, however, different inverters can be coupled to the same (e.g., a single) winding set of the electric motor. In such examples, the electric motor itself does not guarantee any redundancy, but redundancy with regard to controlling the winding sets is at least still provided by the different inverters/power stages. Since unexpected operating conditions occur extremely rarely regarding the motor, this configuration is also acceptable. In such examples, the electric motor can, thus, also simply have three phases, thereby, reducing the manufacturing complexity.

In some examples, at least the third inverter can be coupled to two different supply circuits of the vehicle for supplying power. This substantially guarantees redundancy of the third inverter with regard to different supply circuits of the vehicle, thereby, increasing the reliability of the third inverter. For example, unexpected operating condition incidents in which a specific supply circuit becomes unavailable, inoperable, etc. can be circumvented because the third inverter can then still be coupled to the further supply circuit.

An unexpected operating condition in a inverter is not limited to total inoperability or availability of a inverter. For example, a component of the inverter may also be defective, with the result that the inverter can no longer operate reliably. For example, inverters include a plurality of power switches, one of which may be defective. In addition, an unexpected operating condition in a inverter can also be that the inverter is not functioning in an intended manner. For example, the inverter can provide an output signal which lies outside its intended parameter interval. It can be assumed, in such examples, that the inverter can no longer operate correctly.

In some examples, an unexpected operating condition in a inverter can also occur when a control logic unit coupled to the inverter has a defect and can no longer be used to control the inverter such that the inverter provides desired output signals.

In some examples, an unexpected operating condition in the electronic steering system can occur when a supply circuit of the vehicle experiences an unexpected operating state (e.g., a limited operating state). In some examples, the first inverter assigned to the actuator and is coupled to a first supply circuit. Further, the second inverter assigned to the actuator is coupled to a second supply circuit. Additionally, the third inverter assigned to the actuator can be selectively coupled to the first and the second supply circuits. Consequently, although an unexpected operating condition in one of the supply circuits results in either the first or the second inverter being no longer usable, the third inverter can still be used to operate the electric motor of the actuator according to the first mode because the third inverter can be coupled to both supply circuits.

In some examples, the electronic steering system includes at least one sensor, which can be used to detect an unexpected operating condition in a inverter (or an unexpected operating condition in a control logic unit coupled to the inverter) or a power supply unexpected operating condition. As a result of detection of an unexpected operating condition, the sensor can convey a suitable signal to a control logic unit of the electronic steering system or to a control logic unit coupled to the electronic steering system, for instance, to a higher-level driving control device of the vehicle.

Methods disclosed herein can further be implemented by computer-readable instructions. This means that the method operations can be executed based on one or more data processing devices. In particular, a data processing device can initiate or execute the corresponding operations. For example, a data processing device of a control logic unit of the electronic steering system can detect an unexpected operating condition in the first and/or the second control logic unit or an unexpected operating condition in the power supply, and couple the third control logic unit selectively to the first and/or the second winding set or to at least one additional third winding set of the electric motor.

According to a further aspect, the disclosure also relates to a computer program product comprising commands which, when the program is executed by a computer, cause the computer to perform methods as described herein. The advantages achieved by the herein-described methods are also achieved in a corresponding manner by the computer program product.

According to an additional aspect, the disclosure also relates to a computer-readable storage medium comprising commands which, when the program is executed by a computer, cause the computer to perform the methods as described herein. The advantages achieved by the herein-described methods are also achieved in a corresponding manner by the computer-readable storage medium.

According to an additional aspect, some examples of the disclosure also relate to vehicles having electronic steering systems. The advantages achieved by the herein-described methods are also achieved in a corresponding manner by the vehicles.

Within the meaning of the disclosure, vehicles can include in particular land-based vehicles, namely including off-road vehicles and on-road vehicles such as passenger cars, buses, trucks and other utility vehicles. Vehicles can be manned or unmanned. Vehicles can be driven at least partially electrically, have an internal combustion engine and/or an electric motor that serves as the drive.

All the features explained with regard to the different aspects can be combined individually or in (sub-) combinations with other aspects.

The disclosure and further advantageous examples and developments of the disclosure are described and explained below in greater detail with reference to the examples shown in the drawings.

The following detailed description in conjunction with the accompanying drawings, in which like numbers refer to like elements, is intended as a description of various examples of the disclosed subject matter and is not intended to represent the only examples. Each example described in this disclosure serves merely as an example or illustration and should not be interpreted as preferred or advantageous over other examples. The illustrative examples contained herein do not claim to be exhaustive and do not limit the claimed subject matter to the precise forms disclosed. Various modifications to the described examples and the general principles defined herein can be applied to other examples and uses without departing from the spirit and scope of the described examples. Therefore, the described examples are not limited to the examples shown but have the widest possible scope of application consistent with the principles and features disclosed here.

All the features disclosed below in relation to the examples and/or the accompanying figures can be combined alone or in any sub-combination with features of the aspects of the disclosed examples.

For the purposes of the disclosure, the wording “at least one of A, B and C” means, for example, (A), (B), (C), (A and B), (A and C), (B and C) or (A, B and C), including all further possible combinations if more than three elements are specified. In other words, the expression “at least one of A and B” means in general “A and/or B”, namely “A” alone, “B” alone or “A and B”.

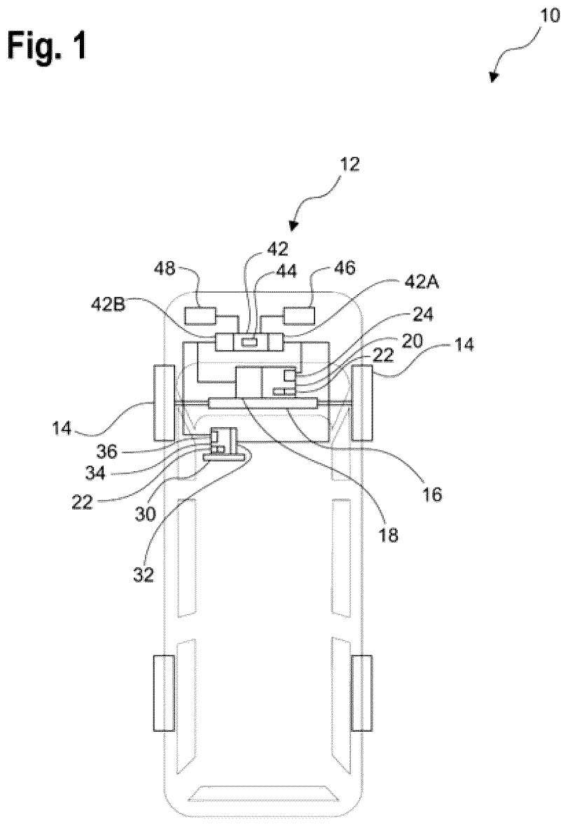

FIG. 1 depicts a schematic representation of a vehicle 10 including an electronic steering system 12 according to teachings disclosed herein.

The vehicle 10 also includes steerable road wheels 14. The steerable road wheels 14 are coupled to a steering rack 16. The steering rack 16 can be moved out of a reference position, for instance, a zero position, producing a steering movement of the steerable road wheels 14. The steerable road wheels 14 can be deflected from a zero position (e.g., a straight-ahead direction of the vehicle 10), for example, so that the vehicle 10 makes a turn. The steerable road wheels 14 accordingly have different wheel angles during a turn, for instance, based on a movement of the steering rack 16.

Although just front-wheel steering is shown here, the vehicle 10 can in general also have, alternatively or additionally, rear-wheel steering of a corresponding design.

The electronic steering system 12 includes a wheel actuator 18 to move the steering rack 16. In the illustrated example, the wheel actuator 18 is coupled to the steering rack 16. In some examples, the wheel actuator 18 can also be coupled to the steerable road wheels 14 in another manner to be able to influence their orientation (e.g., a wheel angle).

According to the illustrated example, the wheel actuator 18 includes an electric motor 20. The electric motor 20 includes at least two winding sets 22, each of which include a group of windings. Each winding set 22 is configured such that when supply signals such as phase voltages are applied, phase currents that can be used to drive a rotor of the electric motor 20 are set up in the underlying windings. The rotor can then be coupled to the steering rack 16 and facilitate the movement of the steering rack 16.

In general, the electric motor 20 can have more than two winding sets 22.

Typically, each winding set 22 is three-phase and, therefore, in the illustrated example the electric motor 20 likewise has a 3n-phase design, with n=2 (e.g., 6-phase). However, the electric motor 20 can also include additional winding sets 22, and n can be greater than 2, for instance 3 or 4. The electric motor 20 is then accordingly 9-phase or 12-phase.

The wheel actuator 18 also includes at least one wheel sensor 24. In general, a plurality of wheel sensors 24 can also be provided. The wheel sensor 24 is configured to detect a position and/or a movement of the steerable road wheels 14 or of a component (e.g., the steering rack 16) coupled thereto. By detecting the position of the steering rack 16 the wheel angle of the steerable road wheels 14 can be determined. The orientation of the steerable road wheels 14 can hence be ascertained.

Although the wheel sensor 24 is configured in the illustrated example to be part of the wheel actuator 18, wheel sensors 24 can alternatively also be located separately from the wheel actuator 18 yet still be configured to detect a position and/or a movement of the steerable road wheels 14 of the vehicle 10 or of a component coupled thereto. For example, the wheel sensor 24 can be coupled to the steering rack 16 separately from the wheel actuator 18.

The electronic steering system 12 of the vehicle 10 also includes a steering wheel 30. Using the steering wheel 30, a driver of the vehicle 10 can provide steering input for the vehicle 10 to steer the vehicle 10 in a desired direction.

A steering-wheel actuator 32 of the electronic steering system 12 is coupled to the steering wheel 30. The steering-wheel actuator 32 includes a further electric motor 34. The electric motor 34 of the steering-wheel actuator 32 likewise includes two winding sets 22. In some examples, the electric motor 34 can also include a plurality of winding sets 22. The winding sets 22 of the electric motor 34 of the steering-wheel actuator 32 are configured to work in a corresponding manner to the winding sets 22 of the electric motor 20 of the wheel actuator 18. This means that the winding sets 22 of the electric motor 34 are configured to drive a rotor of the electric motor 34. As a result, the electric motor 34 can apply a torque to the steering wheel 30 of the vehicle 10 that constitutes a feedback torque for the driver to impart to the driver a feeling of the lateral guidance, or later control, of the vehicle 10.

Of course, the winding sets 22 of the electric motors 20, 34 can be dimensioned differently.

In the illustrated example, the electric motor 34 of the steering-wheel actuator 32 has two winding sets 22 and is hence 6-phase.

The electronic steering system 12 also includes a steering-wheel sensor 36, which is part of the steering-wheel actuator 32. In some examples, more steering-wheel sensors 36 (e.g., 2, 3, 4, etc.) can also be provided. The steering-wheel sensor 36 is configured to detect a steering input on the basis of a steering-wheel angle of the steering wheel 30 or of a component coupled thereto (for example a steering column) with respect to a reference position.

In some examples, the steering-wheel sensor 36 can also be separate from the steering-wheel actuator 32 yet still be configured to detect a position and/or a movement of the steering wheel 30 of the vehicle 10 or of a component coupled thereto.

The electronic steering system 12 of the vehicle 10 includes a control logic unit 42 in the illustrated example. The control logic unit 42 includes at least one data processing device 44, and is coupled to the wheel actuator 18, the wheel sensor 24, the steering-wheel actuator 32 and the steering-wheel sensor 36.

In some examples, the electronic steering system 12 can also include separate control logic units 42, one assigned to the wheel actuator 18 and one to the steering-wheel actuator 32. In the illustrated example, however, the control functions are combined in a single control logic unit 42.

In some examples, the electronic steering system 12 includes a higher-level driving control device 46 and an output device 48, which are each coupled to the control logic unit 42.

The higher-level driving control device 46 serves the drive of the vehicle 10. The higher-level driving control device 46 is configured to receive a control signal from the control logic unit 42 and, in response to the control signal, reduce a maximum speed achievable by the vehicle 10.

In some examples, the higher-level driving control device 46 can be configured to provide overall vehicle control (e.g., control of the vehicle 10 in terms of a vehicle longitudinal axis, a vehicle transverse axis and a vehicle vertical axis). For this purpose, the higher-level driving control device 46 can output corresponding control signals to the control logic unit 42.

The output device 48 is configured to output a notification to a driver of the vehicle 10, for instance about an unexpected operating condition in the electronic steering system 12. The output device 48 can receive for this purpose a corresponding control signal from the control logic unit 42.

The control logic unit 42 acts as a link between the wheel actuator 18 and the steering-wheel actuator 32. The control logic unit 42 produces a change in the wheel angles of the steerable road wheels 14 of the vehicle 10 according to the steering input via the steering wheel 30. Further, the control logic unit 42 substantially ensures torque feedback for the driver of the vehicle 10 at the steering wheel 30 based on the change in the wheel angle of the steerable road wheels 14.

In some examples, different control logic units 42A, 42B can be provided (see FIG. 1). Then a first control logic unit 42A is assigned to the wheel actuator 18. The second control logic unit 42B is assigned to the steering-wheel actuator 32 separately from the first control logic unit 42A. In such examples, the corresponding control logic units 42 can also be spatially separated from each other. For simplicity, the different control logic units 42A, 42B are combined in the illustrated example into a single control logic unit 42.

In the illustrated example, the control logic unit 42 is also configured to detect an unexpected operating condition inside the electronic steering system 12 or an unexpected operating condition in the power supply of a supply circuit that is coupled to the electronic steering system 12. In some examples, detection of the unexpected operating condition can also be performed by the higher-level driving control device 46. As a result of the detection of the unexpected operating condition, the control logic unit 42 of the electronic steering system 12 can output a control signal to the higher-level driving control device 46 and/or the output device 48 to reduce a maximum speed achievable by the vehicle 10 and/or to output a notification to the driver about the occurrence of an unexpected operating condition in the electronic steering system 12.

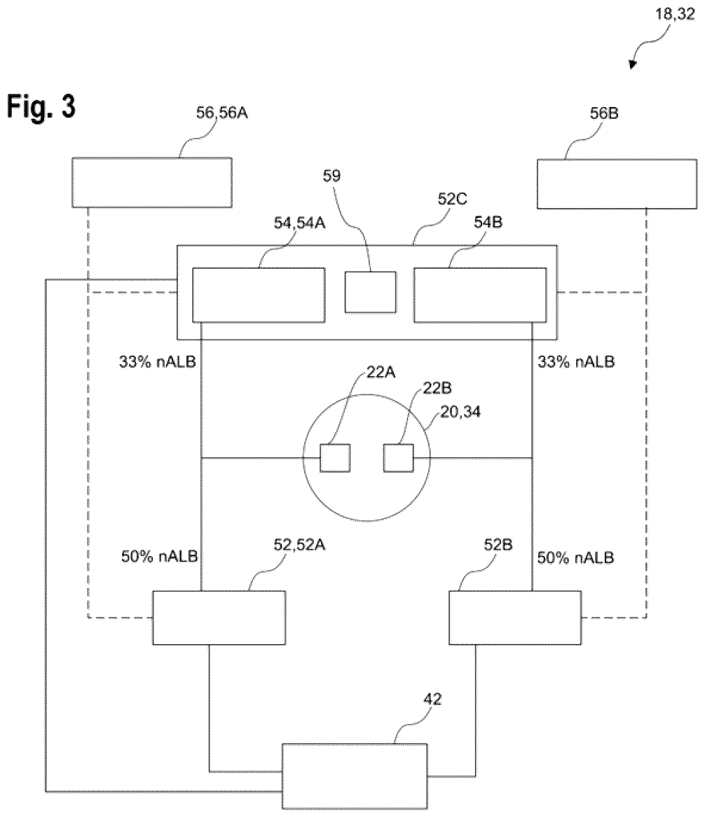

Each electric motor 20, 34 is coupled to corresponding inverters, which provide phase voltages or phase currents for the winding sets 22 of the electric motors 20, 34. This is explained in detail with reference to FIGS. 3-8.

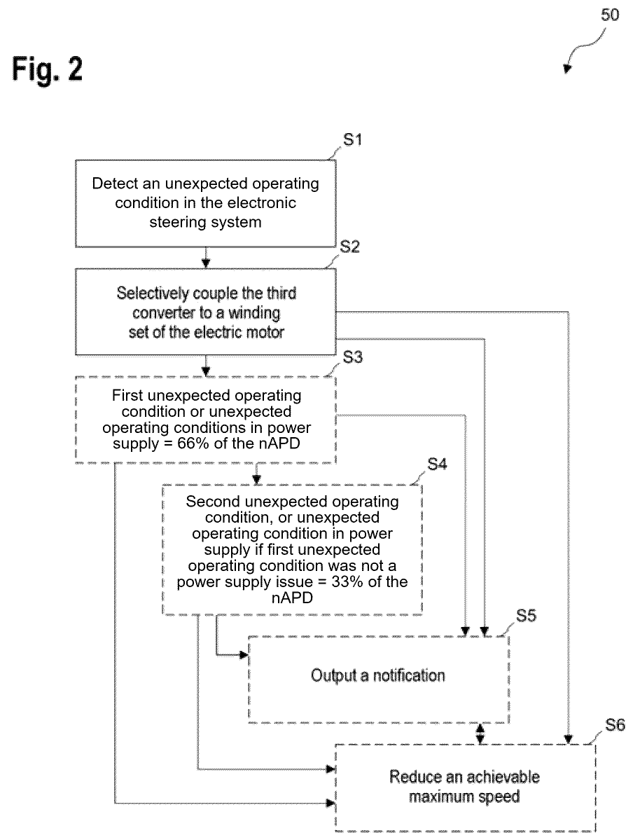

FIG. 2 is a flowchart representative of example machine-readable instructions and/or example operations that may be executed, instantiated, and/or performed by example programmable circuitry to implement an example method 50 of operating a vehicle including an electronic steering system.

In the illustrated example, optional operations are shown in dashed boxes.

In connection with the method 50, FIGS. 3-8 show schematic representations of an actuator 18, 32 of the electronic steering system 12 according to various examples.

The actuator 18, 32 includes an electric motor 20, 34. According to the illustrated example of FIG. 3, the electric motor 20, 34 includes two winding sets 22 and is, therefore, 6-phase.

Referring to FIG. 3, the actuator 18, 32 includes a plurality of inverters 52, which are assigned to the electric motor 20, 34. Each inverter 52 is configured to provide phase voltages for applying to windings of a winding set 22 of the electric motor 20, 34.

According to the illustrated example, the first inverter 52A is coupled to a first winding set 22A of the electric motor 20, 34. Further, the second inverter 52B is coupled to the second winding set 22B of the electric motor 20, 34. Additionally, the actuator 18, 32 of the electronic steering system 12 includes a third inverter 52C, which can be coupled selectively to the first winding set 22A and/or to the second winding set 22B. The third inverter 52C includes two mutually separate power electronics units 54, 54A, 54B, of which one is coupled to the first winding set 22A and one to the second winding set 22B of the electric motor 20, 34.

In addition, the actuator 18, 32 of the electronic steering system 12 is coupled to two external supply circuits 56, 56A, 56B for supplying power. According to the illustrated example, the first inverter 52A and the third inverter 52C are coupled to the first supply circuit 56A. Additionally, the second inverter 52B and the third inverter 52C are coupled to the second supply circuit 56B. This means that the third inverter 52C is coupled to both supply circuits 56A, 56B. The first power electronics unit 54A of the third inverter 52C is coupled directly to the first supply circuit 56A. The second power electronics unit 54B of the third inverter 52C is coupled directly to the second supply circuit 56B. The control logic unit 42 of the third inverter 52C operates both from the first supply circuit 56A and from the second supply circuit 56B, for instance, via a circuit comprising diodes 59.

In some examples, the inverters 52 include a plurality of power switches, the switch settings of which are defined via control signals, which are provided indirectly (e.g., via a pulse width modulator and/or gate driver circuits) by the control logic unit 42 coupled to the respective inverters 52. According to the illustrated example, the inverters 52 are coupled to a single shared control logic unit 42 of the electronic steering system 12. In some examples, an individual control logic unit 42 can also be assigned to each inverter 52, thereby, further increasing the redundancy of the actuator 18, 32 and hence of the electronic steering system 12.

According to the illustrated example, both the first inverter 52A and the second inverter 52B are configured to be able to supply the respective winding sets 22 of the electric motor 20, 34 with electrical powers equal to 50% of the nominal actuator power demand (nAPD), (e.g., the power demand of the electric motor 20, 34 to output a nominal maximum torque, for example, to an external mechanical component coupled to the electric motor 20, 34, such as the steering rack 16 or the steering wheel 30).

In the illustrated example, the third inverter 52C is configured such that it can use either the first power electronics unit 54A or the second power electronics unit 54B to output in total 33% of the nAPD to one of the winding sets 22 of the electric motor 20, 34. This means that, with regard to its power output, the third inverter 52C is more compact than the first inverter 52A and the second inverter 52B. As a result, the actuator 18, 32 and hence also the electronic steering system 12 are compact.

In the following example discussions about unexpected operating conditions relating to the examples of the disclosure, an unexpected operating condition that occurs is with reference to the first inverter 52A and/or the first supply circuit 56A. Of course, the unexpected operating condition can also occur in relation to the second inverter 52B or the second supply circuit 56B. Correspondingly, the third inverter 52C, if already coupled to the electric motor 20, 34, can also be in an unexpected operating state. The explanations can then be applied correspondingly. In addition, the second unexpected operating condition is with reference to an unexpected operating condition relating to the second inverter 52B or alternatively to a first unexpected operating condition in a supply circuit 56A, 56B (unexpected operating condition of the power supply) if previously no power supply issue has occurred but just an unexpected operating condition relating to a inverter 52. Of course, the third inverter 52C can also be in an unexpected operating state. The explanations can then be applied correspondingly.

In a normal operating mode of the actuator 18, 32, the first inverter 52A and the second inverter 52B are coupled to the respective winding sets 22 of the electric motor 20, 34. The inverters 52 jointly provide 100% of the nAPD for the electric motor 20, 34.

If an unexpected operating condition relating to the first inverter 52A or an unexpected operating condition of the power supply relating to the first supply circuit 56A now occurs, the power electronics unit 54B of the third inverter 52C can be supplied by the second supply circuit 56B. In such examples, the method 50 (see FIG. 2) includes the operation S1, in which an unexpected operating condition in the electronic steering system 12 is detected of a type that makes a inverter 52 (e.g., the first inverter 52A), no longer usable. In addition, the method 50 includes the subsequent operation S2, in which the third inverter 52C selectively controls and supplies the first winding set 22A of the electric motor 20, 34.

As a result of an unexpected operating condition relating to the first inverter 52A, the electric motor 20, 34 can be used, in accordance with the first mode, based on the second winding set 22B, which is still supplied with 50% of the nAPD by the second inverter 52B, and based on the first winding set 22A, which is still supplied with 33% of the nAPD by the first power electronics unit 54A of the third inverter 52C. According to this example, the electric motor 20, 34 is, therefore, still supplied with 83% of the nAPD in the first mode. The method 50 accordingly includes the subsequent operation S3, in which the electric motor 20, 34, in the event of a first unexpected operating condition in a inverter 52A, can at least still operate in a first mode, in which a total power output from the operational inverters 52B, 52C to the electric motor 20, 34 still equals at least 66% (e.g., a total power greater than or equal to 66% such as 83% in the illustrated example) of the nAPD. This is sufficient still to be able to operate the electric motor 20, 34 of the actuator 18, 32 on a permanent basis.

If subsequently an unexpected operating condition also occurs relating to the second inverter 52B, or if, in so far as the first unexpected operating condition occurs in a inverter 52 (e.g., in the first inverter 52A), subsequently an unexpected operating condition occurs relating to a supply circuit 56A, 56B (e.g., the second supply circuit 56B), then the electric motor 20, 34 can operate in a second mode at least still with 33% (e.g., greater than or equal to 33%) of the nAPD on the basis of the first winding set 22A and the coupling to the first power electronics unit 54A. If, instead, the third inverter 52C is in an unexpected operating state, then the second winding set 22B of the electric motor 20, 34 can still be supplied with 50% of the nAPD by the second inverter 52B. The method 50 accordingly includes the subsequent operation S4, in which the electric motor 20, 34, in the event of a second unexpected operating condition in a inverter 52B, can at least operate still in a second mode, in which a power output from the operational inverter 52C to the electric motor 20, 34 still equals at least 33% (e.g., greater than or equal to 33%) of the nAPD. The power output in the second mode is sufficient for the electric motor 20, 34 of the actuator 18, 32 to operate at least still with reduced power parameters, so that the driver of the vehicle 10 can steer the vehicle 10 into a suitable parked position.

The connecting of the inverters 52 to the winding sets 22 of the electric motor 20, 34 ensures that at no point in time is more than 50% of the nAPD supplied to a winding set 22 of the electric motor 20, 34 irrespective of the mode.

In addition, the method 50 can be extended by operations S5 and S6. Regarding the operation S5, if an unexpected operating condition in a inverter 52 or a power supply occurs, the control logic unit 42 of the electronic steering system 12 outputs a notification to the driver of the vehicle 10, for instance, via the output device 48. This can increase the informative value for the driver of the vehicle 10 so that the driver of the vehicle 10 can get the electronic steering system 12 inspected.

Alternatively or additionally, the method 50 can also include the operation S6, in which a maximum speed achievable by the vehicle 10 is reduced. For this purpose, the control logic unit 42 of the electronic steering system 12 can, for example, output a suitable control signal to the higher-level driving control device 46 of the vehicle 10, which controls the drive of the vehicle 10.

Operations S5 and/or S6 can be initiated as a result of operations S2, S3 and/or S4.

Although detection of unexpected operating conditions related to the inverters 52 and the supply circuits 56 is explained in the above example with reference to the control logic unit 42 of the electronic steering system 12, detection of unexpected operating conditions and initiation of measures can also be performed in general by a control logic unit of the vehicle 10 that is external to the electronic steering system 12, for instance, the higher-level driving control device 46.

The arrangement of the inverters 52 and the selective coupling of the third inverter 52C to the winding sets 22 of the electric motor 20, 34 substantially ensure that the actuator 18, 32 of the electronic steering system 12 operates with high reliability. This increases the functionality of the electronic steering system 12 compared with existing approaches while enabling the third inverter 52C to be advantageously smaller than the first inverter 52A and the second inverter 52B.

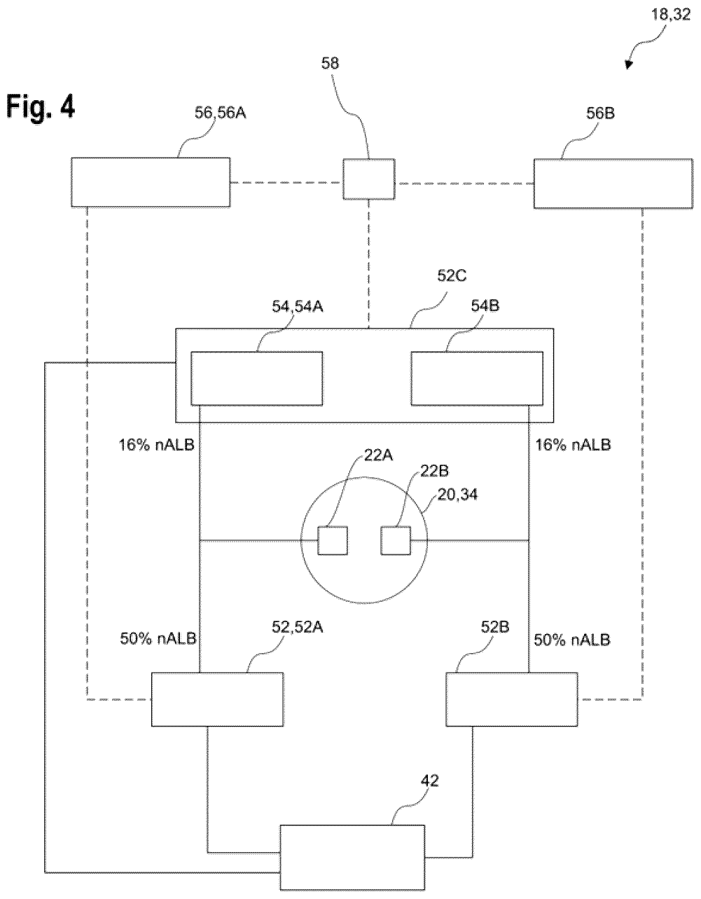

Regarding the further examples of the actuator 18, 32 of the electronic steering system 12 (FIGS. 4-8), only the differences are discussed here.

According to the examples of the actuator 18, 32 of FIG. 4, the switching device 58 used to couple the third inverter 52C to the different supply circuits 56A, 56B is external to the third inverter 52C. For example, the switching device 58 can also be part of a control logic unit, for example the control logic unit 42 of the electronic steering system 12. The switching device 58 can be configured to switch selectively back and forth between the supply circuits 56A, 56B. In some examples, the switching device 58 can also be configured to combine both supply circuits 56A, 56B, for instance, via a diode circuit (logic circuit). The switching device 58 can be an external component but also part of the third inverter 52C.

Additionally, the first power electronics unit 54A and the second power electronics unit 54B of the third inverter 52C are configured such that they can each output only 16% of the nAPD to winding sets 22 of the electric motor 20, 34.

In the first mode (e.g., an unexpected operating condition in the inverter 52A or the supply circuit 56A), the second winding set 22B of the electric motor 20, 34 is still supplied with 50% of the nAPD by the second inverter 52B. In addition, the first winding set 22A of the electric motor 20, 34 is supplied with 16% of the nAPD by the first power electronics unit 54A of the third inverter 52C. The total power output from the operational inverters 52, therefore, equals 66% of the nAPD in the first mode.

If the second inverter 52B is also in an unexpected operating state, then each of the winding sets 22A, 22B of the electric motor 20, 34 can still be supplied with 16% of the nAPD by the two power electronics units 54A, 54B of the third inverter 52C. If the third inverter is in an unexpected operating state, then the second winding set 22B can at least still be supplied with 50% of the nAPD by the second inverter 52B. The total power output from the third inverter 52C therefore equals at least 33% of the nAPD in the second mode.

In some examples, in the event of a loss of a supply circuit 56A, 56B, at least 66% of the nAPD (e.g., an unexpected operating condition of the power supply is the first unexpected operating condition) or at least 33% of the nAPD (e.g., an unexpected operating condition of the power supply is the second unexpected operating condition after an initial unexpected operating condition in a inverter 52) is still available.

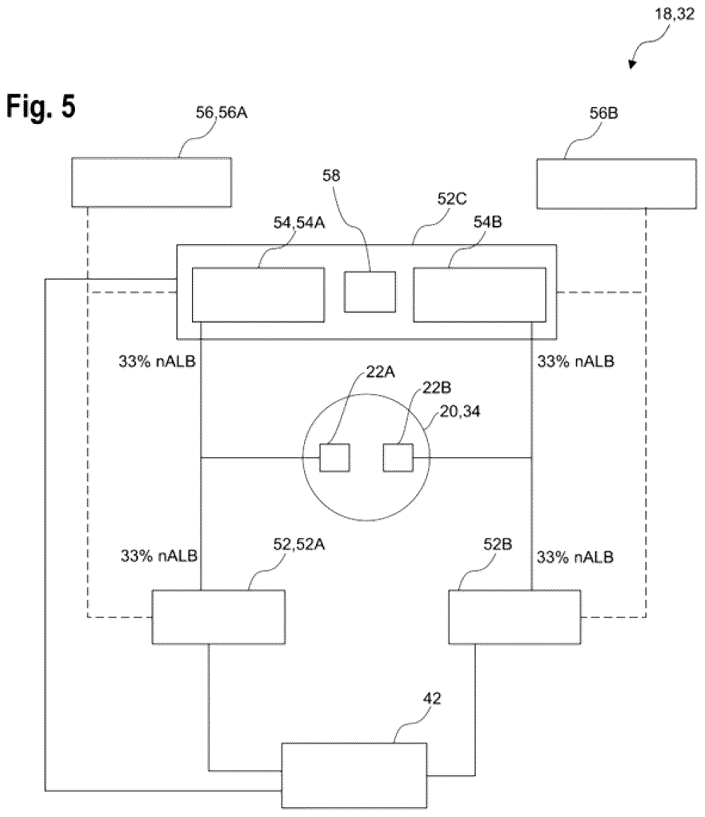

The example of the actuator 18, 32 from FIG. 5 essentially corresponds to that of FIG. 4. The first and second inverters, however, each have a compact configuration such that they each have a maximum power output of 33% of the nAPD. This further reduces the complexity of the actuator 18, 32 and hence of the electronic steering system 12. Moreover, unlike in the example of FIG. 4, the power electronics units 54A, 54B are configured such that they each have a maximum power output of 33% of the nAPD. The maximum power output from all the inverters 52, therefore, equals 133% of the nAPD. In addition, the switching device 58 is internal to the third inverter 52C.

In the normal operating mode (e.g., all the inverters 52 and supply circuits 56 are operational without an unexpected operation condition) all the inverters 52 are coupled to windings 22 of the electric motor 20, 34. The first winding set 22A of the electric motor 20, 34 is supplied with 33% of the nAPD by the first inverter 52A and additionally with a portion by the first power electronics unit 54A of the third inverter 52C. The second winding set 22B of the electric motor 20, 34 is supplied with 33% of the nAPD by the second inverter 52B and additionally with a portion by the second power electronics unit 54B of the third inverter 52C. The third inverter 52C is configured to substantially ensure that each winding set 22 of the electric motor 20, 34 is supplied with a maximum of 50% of the nAPD. For example, the third inverter 52C can be controlled accordingly by the control logic unit 42. This means that in the normal operating mode of the electric motor 20, 34, all the inverters 52 are coupled to the electric motor 20, 34. In other examples, the demanded powers can be freely distributed differently between the first inverter 52A and the first power electronics unit 54A or between the second inverter 52B and the second power electronics unit 54B as long as, when the nAPD demand is a maximum, in total each winding set 22 of the electric motor 20, 34 is supplied with a maximum of 50% of the nAPD.

In the first mode, the second winding set 22B is supplied with 33% of the nAPD by the second inverter 52B, and the first winding set 22A with 33% of the nAPD by the third inverter 52C. In the second mode, the third inverter 52C is still configured to provide 33% of the nAPD for at least one winding set 22 of the electric motor 20, 34. If, instead, the third inverter 52C is in an unexpected operating state, then the second inverter 52B can still provide 33% of the nAPD for the second winding set 22B.

In the illustrated example, in the event of a loss of a supply circuit 56A, 56B, at least 66% of the nAPD (e.g., an unexpected operating condition of the power supply is the first unexpected operating condition) or at least 33% of the nAPD (e.g., an unexpected operating condition of the power supply is the second unexpected operating condition after an initial unexpected operating condition in a inverter 52) is still available.

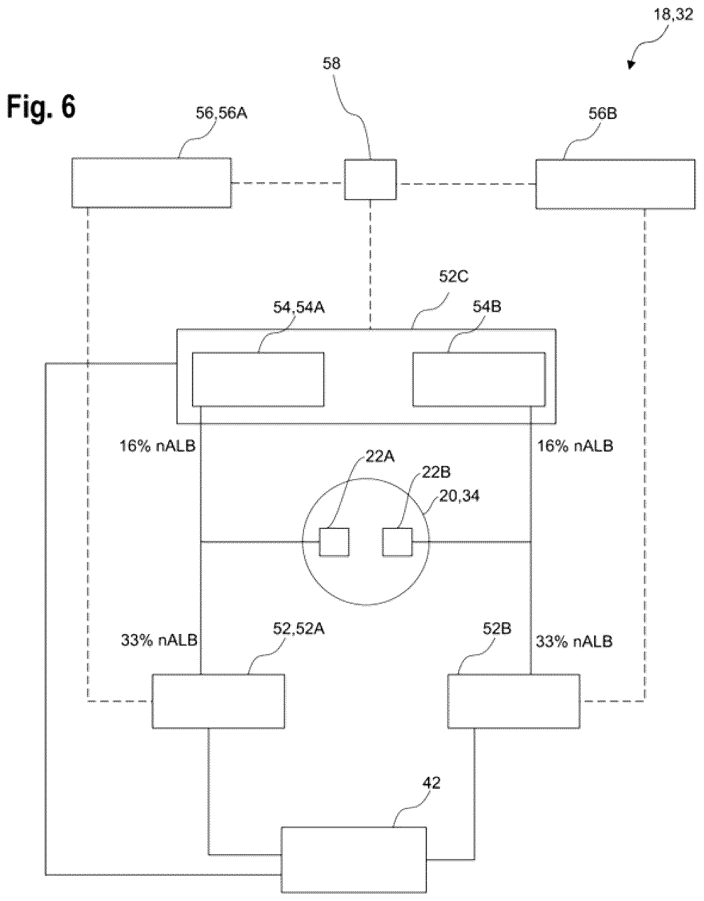

The example of the actuator 18, 32 from FIG. 6 essentially corresponds to that of FIG. 4. The first and second inverters, however, each have a compact configuration such that they each have a maximum power output of 33% of the nAPD. This further reduces the complexity of the actuator 18, 32 and hence of the electronic steering system 12. In the first mode, the second winding set 22B is supplied with 33% of the nAPD by the second inverter 52B, and additionally with 16% of the nAPD by the third inverter 52C. In addition, the first winding set 22A is with 16% of the nAPD by the third inverter 52C. The total power output from the operational inverters 52 then equals 66% of the nAPD. In the second mode, the third inverter 52C is configured to provide 16% of the nAPD for each of the two winding sets 22 of the electric motor 20, 34. If, instead, the third inverter 52C is in an unexpected operating state, then the second inverter 52B can still provide 33% of the nAPD for the second winding set 22B.

In the illustrated example, in the event of a loss of a supply circuit 56A, 56B, at least 66% of the nAPD (e.g., an unexpected operating condition of the power supply is the first unexpected operating condition) or at least 33% of the nAPD (e.g., an unexpected operating condition of the power supply is the second unexpected operating condition after an initial unexpected operating condition in a inverter 52) is still available.

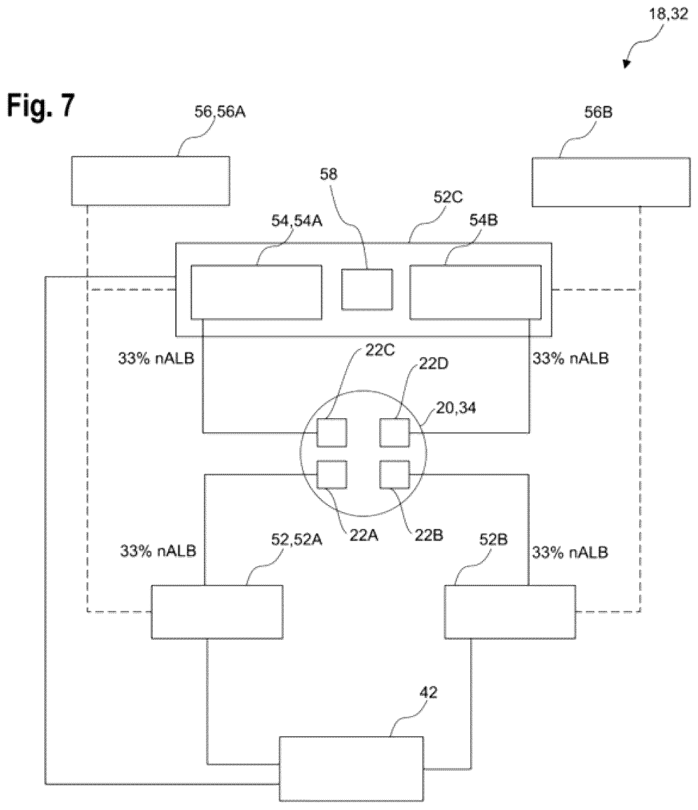

The example actuator 18, 32 from FIG. 7 essentially corresponds to that of FIG. 5. In the illustrated example, however, the electric motor 20, 34 has four winding sets 22 and is thus 12-phase. The inverters 52 are configured for the direct supply of power.

In the normal operating mode of the electric motor 20, 34, all of the inverters 52 are active. The first winding set 22A of the electric motor 20, 34 is supplied with a portion of the nAPD by the first inverter 52A. The second winding set 22B of the electric motor 20, 34 is supplied with a portion of the nAPD by the second inverter 52B. The third and fourth winding sets 22C, 22D are each supplied with a portion of the nAPD by the power electronics units 54A, 54B of the third inverter 52C. The third inverter 52C, however, is configured such that a maximum of 33% of the nAPD is output to the electric motor 20, 34. The inverters 52 are additionally configured such that each inverter can output a maximum of 33% of the nAPD to a winding set 22 of the electric motor 20, 34. The inverters 52 are also configured such that the total (e.g., active) power output from the inverters 52 is a maximum of 100% of the nAPD. For example, the control logic unit 42 can perform corresponding control. This means that, in the normal operating mode of the electric motor 20, 34, the third inverter 52C supplies just one winding set 22 of the electric motor 20, 34 with a power of 33% of the nAPD, or the third and fourth winding set 22C, 22D, with the total power output from the third inverter 52C equal to 33% of the nAPD.

In some examples, the demanded power can be freely distributed differently between the first inverter 52A and the first power electronics unit 54A or between the second inverter 52B and the second power electronics unit 54B as long as, when the nAPD demand is a maximum, in total 100% of the nAPD is reached and the power electronics units 54 each output no more than 33% of the nAPD. Since only 75% of the maximum nominal power is used to provide 100% of the nAPD in the case of an even distribution between the power electronics units 54 (e.g., inverters 52), there is consequently less load on the components. This can reduce the thermal load, which can result in a prolonged operating life.

In the first mode, the second winding set 22B is supplied with 33% of the nAPD by the second inverter 52B, and the third or fourth winding set 22C, 22D is supplied with 33% of the nAPD by the first or second power electronics unit 54A, 54B of the third inverter 52C. If the third inverter 52C is in an unexpected operating state, then in the first mode, the first winding set 22A and the second winding set 22B are each supplied with 33% of the nAPD by the first inverter 52A and the second inverter 52B. The total power output from the operational inverters 52, thus, equals at least 66% of the nAPD.

In the second mode, at least one winding set 22 can still be supplied with 33% of the nAPD by a inverter 52. Should the first inverter 52A and the second inverter 52B be operating under unexpected operating conditions, then the third inverter 52C can still output 33% of the nAPD to a winding set 22 of the electric motor 20, 34.

In some examples, in the event of a loss of a supply circuit 56A, 56B, at least 66% of the nAPD (e.g., an unexpected operating condition of the power supply is the first unexpected operating condition) or at least 33% of the nAPD (e.g., an unexpected operating condition of the power supply is the second unexpected operating condition after an initial unexpected operating condition in a inverter 52) is still available.

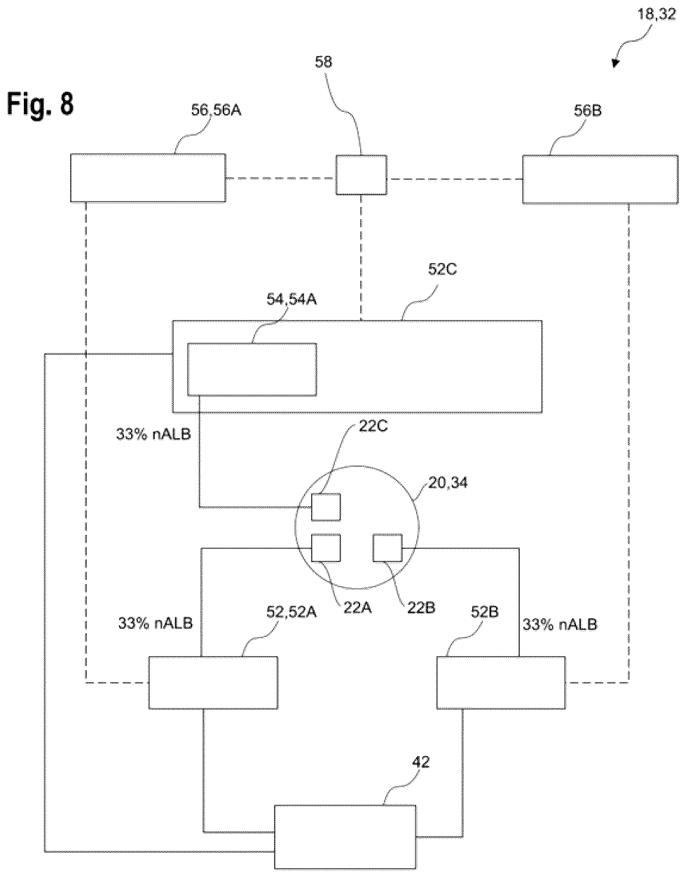

The example of the actuator 18, 32 from FIG. 8 essentially corresponds to that of FIG. 6. The first and second inverters, however, each have a compact configuration such that they each have a maximum power output of 33% of the nAPD. This further reduces the complexity of the actuator 18, 32 and hence of the electronic steering system 12. In addition, the third inverter has just one power electronics unit 54, which is coupled to a third winding set 22C of the electric motor 20, 34. The electric motor 20, 34 therefore has a 9-phase design.

In the first mode, the second winding set 22B is supplied with 33% of the nAPD by the second inverter 52B, and additionally with 33% of the nAPD by the third inverter 52C. The total power output from the operational inverters 52 then equals 66% of the nAPD. In the second mode, the third inverter 52C is still configured to provide 33% of the nAPD for the winding set 22C of the electric motor 20, 34. If, instead, the third inverter 52C is in an unexpected operating state, then the second inverter 52B can still provide 33% of the nAPD for the second winding set 22B.

In some examples, in the event of a loss of a supply circuit 56A, 56B, at least 66% of the nAPD (e.g., an unexpected operating condition of the power supply is the first unexpected operating condition) or at least 33% of the nAPD (e.g., an unexpected operating condition of the power supply is the second unexpected operating condition after an initial unexpected operating condition in a inverter 52) is still available.

The actuators 18, 32 can be implemented in many different ways. This increases the configurability and reliability of the electronic steering system 12. These advantages are achieved even though the third inverter 52C can advantageously be very compact.

Example instructions and/or operations of FIG. 2 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, a hard disk drive (HDD), a flash memory, a read-only memory (ROM), a compact disc (CD), a digital versatile disc (DVD), a cache, a random-access memory (RAM) of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random-access memory of any type, read-only memory of any type, solid-state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

Specific examples disclosed herein use circuits (e.g., one or more circuits) to implement standards, protocols, methods or technology disclosed here, to operatively couple two or more components, to generate information, to process information, to analyze information, to generate signals, to encode/decode signals, to convert signals, to transmit and/or receive signals, to control other apparatuses, etc. Circuits of any type can be used.

In some examples, a circuit such as the control device includes, inter alia, one or more data processing devices such as a processor (e.g., a microprocessor), a central processing unit (CPU), a digital signal processor (DSP), an application-specific integrated circuit (ASIC), a field-programmable gate array (FPGA), a system on a chip (SoC) or the like, or any combinations thereof, and can comprise discrete digital or analog circuit elements or electronics or combinations thereof. In some examples, the circuit includes hardware circuit implementations (e.g., implementations in analog circuits, implementations in digital circuits and the like, and combinations thereof).

In some examples, the circuits include combinations of circuits and computer program products containing software instructions or firmware instructions, which are stored on one or more computer-readable storage means, and interact to cause an apparatus to execute one or more of the protocols, methods or technologies described here. In one example, the circuit technology includes circuits such as, for example, microprocessors or parts of microprocessors, which need software, firmware and the like to operate. In one example, the circuits include one or more processors or parts thereof, and the associated software, firmware, hardware and the like.

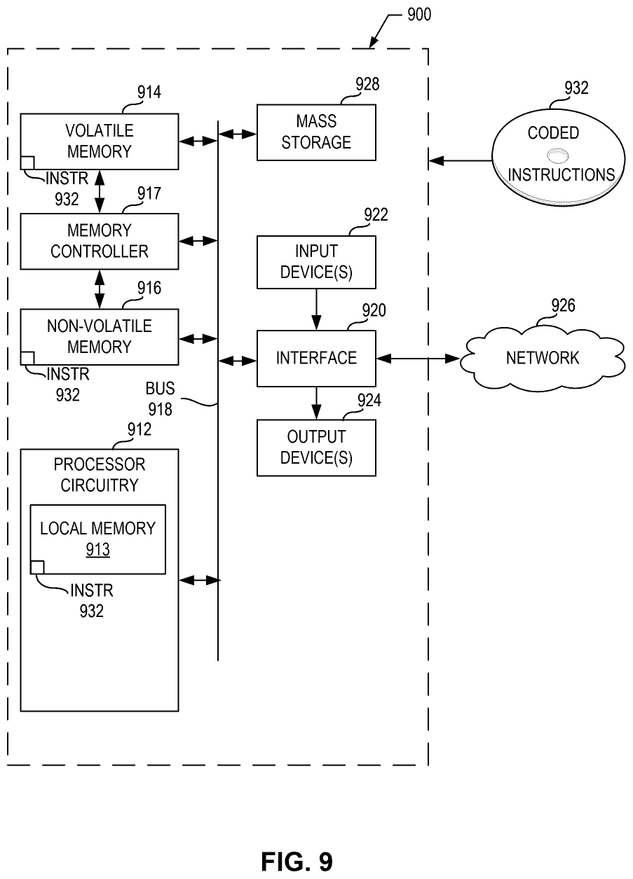

FIG. 9 is a block diagram of an example programmable circuitry platform 900 structured to execute and/or instantiate the example machine-readable instructions and/or the example operations of FIG. 2 to implement the electronic steering system 12 and/or its various components disclosed herein. The programmable circuitry platform 900 can be, for example, a control device, an ECU, a self-learning machine (e.g., a neural network), or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAS, microprocessors, CPUs, graphic processor units (GPUs), video processor units (VPUs), DSPs, and/or microcontrollers from any desired family or manufacturer. The programmable circuitry 912 may be implemented by one or more semiconductor based (e.g., silicon based) devices.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface standard, such as a controller area network (CAN), an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a button, a touchscreen, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), an in-place switching (IPS) display, a touchscreen, etc.), a tactile output device, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 900 of the illustrated example also includes one or more mass storage discs or devices 928 to store firmware, software, and/or data. Examples of such mass storage discs or devices 928 include magnetic storage devices (e.g., floppy disk, drives, hard disk drives (HDDs), etc.), optical storage devices (e.g., Blu-ray disks, CDs, DVDs, etc.), RAID systems, and/or solid-state storage discs or devices such as flash memory devices and/or solid state drives (SSDs).

The machine-readable instructions 932, which may be implemented by the machine-readable instructions of FIG. 3, may be stored in the mass storage device 928, in the volatile memory 914, in the non-volatile memory 916, and/or on at least one non-transitory computer readable storage medium such as a CD or DVD which may be removable.

In this disclosure, reference may be made to quantities and numbers. Unless explicitly stated, such quantities and numbers shall not be regarded as limiting but as examples of the possible quantities or numbers in the context of the disclosure. In this context, the term “a plurality of” can also be used in the disclosure to refer to a quantity or number. In this context, the term “a plurality of” refers to any number greater than one, for example two, three, four, five, etc. The terms “about”, “approximately”, “nearly” etc. mean plus or minus 5% of the stated value.

Although the disclosure has been presented and described with reference to one or more examples, a person skilled in the art will be able to make equivalent changes and modifications after reading and understanding this description and the accompanying drawings.

Example methods, apparatus, systems, and articles of manufacture to enable operating a vehicle with an electronic steering system and electronic steering systems are disclosed herein. Further examples and combinations thereof include the following:

Example 1 includes an electronic steering system for a vehicle, the system includes a first inverter coupled to a first winding set of an electric motor, the first inverter to provide first power to the first winding set, a second inverter coupled to a second winding set of the electric motor, the second inverter to provide second power to the second winding set, and a third inverter including first power electronics coupled to the first winding set, the first power electronics to provide third power to the first winding set, second power electronics coupled to the second winding set, the second power electronics to provide fourth power to the second winding set, and a control device to cause the third inverter to provide the third power, the fourth power, and a portion of the first power, or a portion of the second power based on an unavailability of either of the first inverter or the second inverter.

Example 2 includes any preceding clause(s) of Example 1, wherein the electric motor operates in a first mode based on a total power output equal to at least 66% of an actuator power demand, the total power output provided by ones of the first inverter, the second inverter, or the third inverter that are available.

Example 3 includes any preceding clause(s) of any one or more of Examples 1-2, wherein after one of the remaining inverters becomes unavailable, the electric motor operates in a second mode, based on a power output from an available one of the inverters to the electric motor equal to at least 33% of an actuator power demand.

Example 4 includes any preceding clause(s) of any one or more of Examples 1-3, wherein the third inverter provides 33% of an actuator power demand to each of the first winding set and the second winding set.

Example 5 includes any preceding clause(s) of any one or more of Examples 1-4, wherein the inverters are to be connected to the winding sets to provide each winding set of the electric motor a power output of 50% of an actuator power demand.

Example 6 includes any preceding clause(s) of any one or more of Examples 1-5, wherein the third inverter can be selectively coupled to a third winding set of the electric motor.

Example 7 includes any preceding clause(s) of any one or more of Examples 1-6, wherein a separate control logic unit is assigned to each inverter, and wherein the control logic units are coupled to one another.

Example 8 includes any preceding clause(s) of any one or more of Examples 1-7, wherein after any of the inverters becomes unavailable, the control device is to cause generation of a notification for a driver of the vehicle.

Example 9 includes any preceding clause(s) of any one or more of Examples 1-8, wherein the electric motor is 3n-phase, wherein n is greater than or equal to 1.

Example 10 includes any preceding clause(s) of any one or more of Examples 1-9, wherein the first inverter, the second inverter, and the third inverter are coupled to two different power supply circuits of the vehicle.

Example 11 includes a method for operating an electronic steering system for a vehicle, the method includes detecting an unavailability of a first inverter coupled to a first winding set or an unavailability of a second inverter coupled to a second winding set, and selectively coupling a third inverter to either the first winding set or the second winding set corresponding to the unavailable inverter or to at least one additional third winding set.

Example 12 includes an electronic steering system for a vehicle, the system includes a first power supply, a second power supply, a first inverter coupled to the first power supply and a first winding set of an electric motor, the first inverter to provide first power to the first winding set, a second inverter coupled to the second power supply and to a second winding set of the electric motor, the second inverter to provide second power to the second winding set, and a third inverter including first power electronics coupled to the first power supply and to the first winding set, the first power electronics to provide third power to the first winding set, second power electronics coupled to the second power supply and to the second winding set, the second power electronics to provide fourth power to the second winding set, and a control device to cause the second power electronics to provide the fourth power and a portion of the first power to the second winding set after an unavailability of the first power supply.

Example 13 includes any preceding clause(s) of Example 12, wherein after the unavailability of the first power supply, the electric motor operates in a first mode, based on a total output from the second inverter and the third inverter to the electric motor equal to at least 66% of a nominal actuator power demand.

Example 14 includes any preceding clause(s) of any one or more of Examples 12-13, wherein after an unavailability of the second inverter, the electric motor can still operate in a second mode based on a power output from the second power electronics to the electric motor equal to at least 33% of an actuator power demand.

Example 15 includes any preceding clause(s) of any one or more of Examples 12-14, wherein the third inverter provides a maximum of 33% of an actuator power demand to each of the first winding set and the second winding set.

Example 16 includes any preceding clause(s) of any one or more of Examples 12-15, wherein the inverters are to be connected to the winding sets to provide each winding set of the electric motor a power output of 50% maximum of an actuator power demand.

Example 17 includes any preceding clause(s) of any one or more of Examples 12-16, wherein the third inverter can be selectively coupled to a third winding set of the electric motor.

Example 18 includes any preceding clause(s) of any one or more of Examples 12-17, wherein a separate control logic unit is assigned to each inverter, and wherein the control logic units are coupled to one another.

Example 19 includes any preceding clause(s) of any one or more of Examples 12-18, wherein after the unavailability of the first inverter, the control device is to cause generation of a notification for a driver of the vehicle.

Example 20 includes any preceding clause(s) of any one or more of Examples 12-19, wherein the electric motor is 3n-phase, wherein n is greater than or equal to 1.

1. An electronic steering system for a vehicle, the system comprising:
a first inverter coupled to a first winding set of an electric motor, the first inverter to provide first power to the first winding set;
a second inverter coupled to a second winding set of the electric motor, the second inverter to provide second power to the second winding set; and
a third inverter including:
first power electronics coupled to the first winding set, the first power electronics to provide third power to the first winding set;
second power electronics coupled to the second winding set, the second power electronics to provide fourth power to the second winding set; and
a control device to:
cause the third inverter to provide the third power, the fourth power, and a portion of the first power, or a portion of the second power based on an unavailability of either of the first inverter or the second inverter.

2. The electronic steering system of claim 1, wherein the electric motor operates in a first mode based on a total power output equal to at least 66% of an actuator power demand, the total power output provided by ones of the first inverter, the second inverter, or the third inverter that are available.

3. The electronic steering system of claim 2, wherein after one of the remaining inverters becomes unavailable, the electric motor operates in a second mode, based on a power output from an available one of the inverters to the electric motor equal to at least 33% of an actuator power demand.

4. The electronic steering system of claim 1, wherein the third inverter provides 33% of an actuator power demand to each of the first winding set and the second winding set.

5. The electronic steering system of claim 1, wherein the inverters are to be connected to the winding sets to provide each winding set of the electric motor a power output of 50% maximum of an actuator power demand.

6. The electronic steering system of claim 1, wherein the third inverter can be selectively coupled to a third winding set of the electric motor.

7. The electronic steering system of claim 1, wherein a separate control logic unit is assigned to each inverter, and wherein the control logic units are coupled to one another.

8. The electronic steering system of claim 1, wherein after any of the inverters becomes unavailable, the control device is to cause generation of a notification for a driver of the vehicle.

9. The electronic steering system of claim 1, wherein the electric motor is 3n-phase, wherein n is greater than or equal to 1.

10. The electronic steering system of claim 1, wherein the first inverter, the second inverter, and the third inverter are coupled to two different supply circuits of the vehicle.

11. A method for operating an electronic steering system for a vehicle, the method comprising:
detecting an unavailability of a first inverter coupled to a first winding set or an unavailability of a second inverter coupled to a second winding set; and
selectively coupling a third inverter to either the first winding set or the second winding set corresponding to the unavailable inverter or to at least one additional third winding set.

12. An electronic steering system for a vehicle, the system comprising:
a first power supply;
a second power supply;
a first inverter coupled to the first power supply and a first winding set of an electric motor, the first inverter to provide first power to the first winding set;
a second inverter coupled to the second power supply and to a second winding set of the electric motor, the second inverter to provide second power to the second winding set; and
a third inverter including:
first power electronics coupled to the first power supply and to the first winding set, the first power electronics to provide third power to the first winding set;
second power electronics coupled to the second power supply and to the second winding set, the second power electronics to provide fourth power to the second winding set; and
a control device to:
cause the second power electronics to provide the fourth power and a portion of the first power to the second winding set after an unavailability of the first power supply.

13. The electronic steering system of claim 12, wherein after the unavailability of the first power supply, the electric motor operates in a first mode, based on a total power output from the second inverter and the third inverter to the electric motor equal to at least 66% of a nominal actuator power demand.

14. The electronic steering system of claim 12, wherein after an unavailability of the second inverter, the electric motor can still operate in a second mode, based on a power output from the second power electronics to the electric motor equal to at least 33% of an actuator power demand.

15. The electronic steering system of claim 12, wherein the third inverter provides a maximum of 33% of an actuator power demand to each of the first winding set and the second winding set.

16. The electronic steering system of claim 12, wherein the inverters are to be connected to the winding sets to provide each winding set of the electric motor a power output of 50% maximum of an actuator power demand.

17. The electronic steering system of claim 12, wherein the third inverter can be selectively coupled to a third winding set of the electric motor.

18. The electronic steering system of claim 12, wherein a separate control logic unit is assigned to each inverter, and wherein the control logic units are coupled to one another.

19. The electronic steering system of claim 12, wherein after the unavailability of the first inverter, the control device is to cause generation of a notification for a driver of the vehicle.

20. The electronic steering system of claim 12, wherein the electric motor is 3n-phase, wherein n is greater than or equal to 1.
